(19) United States
(12) Patent Application Publication
(10) Pub. No.: US 2011/0242197 A1
(43) Pub. Date: Oct. 6, 2011

(54) Magenta Dyes and Inks for Use in Ink-Jet Printing

(75) Inventors: Clive Edwin Foster, Manchester (GB); Gavin Wright, Manchester (GB); Toshiki Fujiwara, Kanagawa (JP)

(73) Assignees: Fujifilm Imaging Colorants, Limited, Manchester (GB); Fujifilm Corporation, Tokyo (JP)

(21) Appl. No.: 13/133,348

(22) PCT Filed: Nov. 26, 2009
(86) PCT No.: PCT/GB2009/051603

§ 371 Date: Jun. 7, 2011

(30) Foreign Application Priority Data
Dec. 20, 2008 (GB) 0823266..2
Jun. 2, 2009 (GB) 0909389.9

(51) Int. Cl. B41J 2/015; C09B 29/46; B41J 2/175; B42D 15/00

(52) U.S. Cl. 347/20; 534/766; 8/682; 347/86; 283/114

(57) ABSTRACT

A compound of Formula (1) and salts thereof:

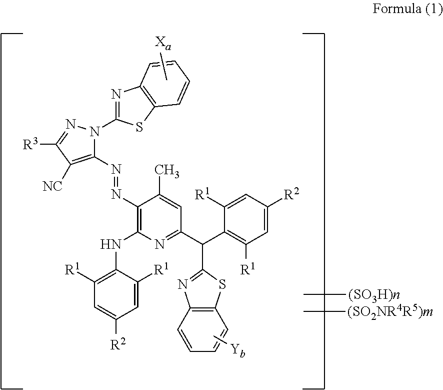

wherein:
R¹ and R² are independently H or optionally substituted C₁₋₄alkyl;
R³ is optionally substituted alkyl, optionally substituted aryl or optionally substituted heteroaryl;
R⁴ and R⁵ are independently H, optionally substituted alkyl optionally substituted aryl or optionally substituted heteroaryl with the proviso that R⁴ and R⁵ do not carry a carboxylic acid substituent;
X and Y are independently an acetyl group, an acetate ester group, an amide group, a sulfoxide group, a sulfone group, a phosphonate group, a nitro group, a nitrile group, an isonitrile group, a quaternary amine, a carbonyl group (other than a carboxylic acid), a polyhaloalkyl group or a halogen atom;
a+b=0 to 4;
n=1 to 6; and
m is greater than 0:
provided that the compounds of Formula (1) contain at least one substituent selected from the group consisting of —SO₃H and —PO₃H₂. Also compositions, inks, printing processes, printed materials and ink-jet cartridges.

This invention relates to dyes, to compositions and inks for ink-jet printers, to printing processes, to printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

While ink-jet printers have many advantages over other forms of printing and image development there are still technical challenges to be addressed. For example, there are the contradictory requirements of providing ink colorants that are soluble in the ink medium and yet display excellent wet-fastness (i.e. prints do not run or smudge when printed). The inks also need to dry quickly to avoid sheets sticking together after they have been printed, but they should not form a crust over the tiny nozzles in the printer head. Storage stability is also important to avoid particle formation that could block the tiny nozzles used in the printer especially since consumers can keep an ink-jet ink cartridge for several months. Furthermore, and especially important with photographic quality reproductions, the resultant images should not bronze or fade rapidly on exposure to light or common oxidising gases such as ozone. It is also important that the shade and chroma of the colorant are exactly right so that any image may be optimally reproduced.

Thus developing new colorants for ink-jet printing presents a unique challenge in balancing all these conflicting and demanding properties.

The present invention provides a compound of Formula (1) and salts thereof:

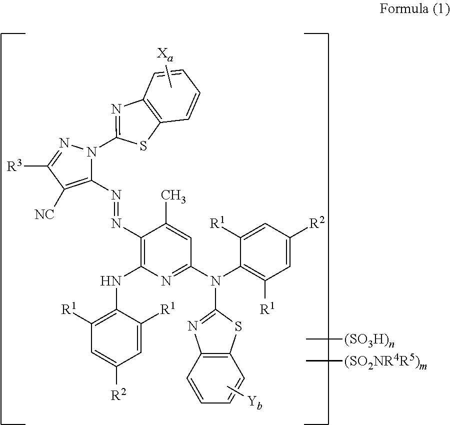

wherein:
R¹ and R² are independently H or optionally substituted C₁₋₄alkyl;
R³ is optionally substituted alkyl, optionally substituted aryl or optionally substituted heteroaryl;
R⁴ and R⁵ are independently H, optionally substituted alkyl, optionally substituted aryl or optionally substituted heteroaryl with the proviso that R⁴ and R⁵ do not carry a carboxylic acid substituent;
X and Y are independently an acetyl group, an acetate ester group, a carbonamide group, a sulfoxide group, a sulfone group, a phosphonate group, a nitro group, a nitrile group, an isonitrile group, a quaternary amine, a carbonyl group (other than a carboxylic acid), a polyhaloalkyl group or a halogen atom;
(a+b)=0 to 4;
n is in the range of from 1 to 7; and
m is greater than 0.

Preferably R¹ and R² are independently H or unsubstituted C₁₋₄alkyl (especially methyl and ethyl).

Preferably R¹ is methyl or ethyl.

Preferably R² is methyl.

Preferably R³ is optionally substituted C₁₋₈alkyl (especially optionally substituted C₁₋₄alky)I optionally substituted phenyl or optionally substituted naphthyl.

It is particularly preferred that R³ is tert-butyl or phenyl, especially tert-butyl.

Preferably R⁴ and R⁵ are independently H, alkyl (especially C₁₋₄-alkyl, more especially methyl), alkyl (especially C₁₋₄-alkyl) carrying at least one sulfonic, or phosphonic acid substituent, C₁₋₄-alkyl carrying one or two, and especially one, hydroxy substituent(s), C₁₋₄-alkyl carrying at least one hydrogen sulfate substituent or aryl (especially phenyl) carrying at least one sulfonic or phosphonic acid substituent (especially carrying at least one sulfonic acid substituent).

It is especially preferred that R⁴ and R⁵ are both hydroxyethyl or ethyl hydrogen sulfate.

Preferably X and Y are independently selected from the group consisting of —Cl, —CN, —NO₂, —CF₃, —SO₂R⁶ wherein R⁶ is optionally substituted alkyl, optionally substituted aryl or optionally substituted heterocyclyl.

More preferably X and Y are independently —Cl and —SO₂R⁶; and particularly —Cl.

Preferably X and Y are the same.

Preferably a is 0 or 1.

Preferably b is 0 or 1.

Preferably (a+b) is 0.

In one embodiment n is preferably n the range of from 4 to 6. In a second embodiment n is preferably in the range of from 4 to 7.

In one particularly preferred embodiment the compounds of Formula (1) are of Formula (2) and salts thereof:

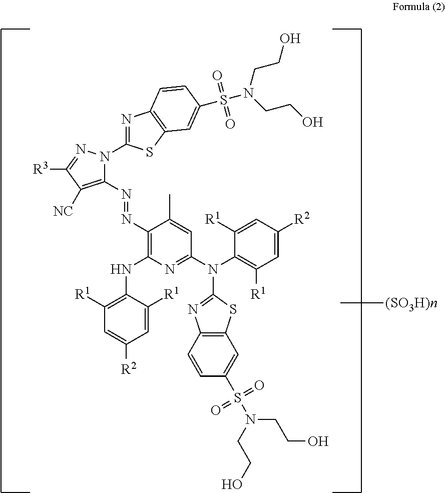

wherein:
R¹ and R² are independently H or optionally substituted C₁₋₄alkyl;
R³ is optionally substituted alkyl, optionally substituted aryl or optionally substituted heteroaryl; and
n is in the range of from 1 to 7.

Preferences for R¹, R² and R³ in compounds of Formula (2) and salts thereof are as preferred above.

Optional substituents which may be present on R¹, R² and R⁶ when they are optionally substituted alkyl are preferably independently selected from: optionally substituted aryl (preferably optionally substituted phenyl), optionally substituted aryloxy (preferably optionally substituted phenoxy), optionally substituted heterocyclyl (including optionally substituted heteroaryl), polyalkylene oxide (preferably polyethylene oxide or polypropylene oxide), CO₂H, SO₃H, PO₃H₂, nitro, cyano, halo, ureido, —SO₂F, hydroxy, ester, sulphate, —NR^{a}R^{b}, —COR^{a}, —CONR^{a}R^{b}, —NHCOR^{a}, carboxyester, —SO₂R^{a}, —SO₂NR^{a}R^{b}, —S—R^{a}, —O—R^{a}, —NH—R^{a}, wherein R^{a}, R^{b} and R^{c} are each independently H, optionally substituted aryl (especially optionally substituted phenyl), optionally substituted alkyl (especially optionally substituted C₁₋₄-alkyl) or optionally substituted heterocyclyl. Optional substituents for any of the above substituents may be selected from the same list of substituents.

Optional substituents which may be present on R³ and R⁶ when they are optionally substituted aryl or optionally substituted heterocyclyl are preferably independently selected from: optionally substituted alkyl (preferably optionally substituted C₁₋₄-alkyl); optionally substituted alkenyl (preferably optionally substituted C₁₋₄-alkenyl), optionally substituted alkynyl (preferably optionally substituted C₁₋₄-alkynyl), optionally substituted alkoxy (preferably optionally substituted C₁₋₄-alkoxy), optionally substituted aryl (preferably optionally substituted phenyl), optionally substituted aryloxy (preferably optionally substituted phenoxy), optionally substituted heterocyclyl (including optionally substituted heteroaryl), polyalkylene oxide (preferably polyethylene oxide or polypropylene oxide), CO₂H, SO₃H, PO₃H₂, nitro, cyano, halo, ureido, —SO₂F, hydroxy, ester, sulphate, —NR^{a}R^{b}, —COR^{a}, —CONR^{a}R^{b}, —NHCOR^{a}, carboxyester, —SO₂R^{a}, —SO₂NR^{a}R^{b}, —S—R^{a}, —O—R^{a}, —NH—R^{a}, wherein R^{a}, R^{b} and R^{c} are each independently H, optionally substituted aryl (especially optionally substituted phenyl), optionally substituted alkyl (especially optionally substituted C₁₋₄-alkyl) or optionally substituted heterocyclyl. Optional substituents for any of the above substituents may be selected from the same list of substituents.

Optional substituents for R⁴ and R⁵ may be selected from any of those listed above for R¹, R², R³ and R⁶ apart from carboxy.

The compounds of Formula (1) are also preferably free from fibre reactive groups. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups excluded from the compounds of Formula (1) there may be mentioned aliphatic sulfonyl groups which contain a sulfate ester group in beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluoro-cyclobutenyl carbonyl, tetrafluorocyclobutylethenyl carbonyl, trifluoro-cyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring, for example a triazinyl halide.

Acid and basic groups on the compounds of Formula (1), particularly acid groups, are preferably in the form of a salt. Thus, the Formulae shown herein include the compounds in free acid and in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially sodium salts.

The compounds of Formula (1) may be converted into a salt using known techniques.

The compounds of Formula (1) may exist in tautomeric forms other than those shown in this specification. These tautomers are included within the scope of the present invention. However, tautomers may not bear a substituent on the hydroxy/enol oxygen.

The skilled person will appreciate that the compounds of the present invention may be prepared by means of a number of processes.

In a first preferred process components carrying sulfonic acid and sulfonamide substituents are coupled to provide discrete compounds of Formula (1).

In a second preferred process an intermediate is assembled which corresponds to a compound of Formula (1) but carries only sulfonamide groups. In the second preferred process the final step is sulfonation to yield a compound of Formula I. This may conveniently be achieved by means of treatment with oleum. The product of this reaction will be a polydisperse mixture containing different species with differing levels of sulfonic acid. Also some sulfonating agents, such as fuming sulfuric acid, can convert the sulfonamide substituents to sulfonic acid. Thus m and n will be an average values.

In a third preferred process an intermediate is assembled which corresponds to a compound of Formula (1) but carries only sulfonic acid groups or an active analogue thereof, such as sulfonyl chloride, in a known position. In this process the final step is the conversion of sulfonic acid groups (or a active analogues thereof) to sulfonamides. This may be conveniently achieved by first converting the sulfonic acid groups into sulfonyl chlorides (if required) by reacting with, for example, chlorosulfonic acid and/or a chlorinating agent (e.g. POCl₃, PCl₅ or thionyl chloride). The sulfonyl chloride groups so formed are reacted with an amine of formula HNR⁴R⁵, wherein R⁴ and R⁵ are as hereinbefore defined. When a sulfonyl chloride is reacted with an amine in an aqueous environment there are two competing reactions. In one reaction the sulfonyl chloride reacts with the amine to give a sulfonamide group and in the other the sulfonyl chloride hydrolyses back to sulfonic acid. The skilled person would know this and so would appreciate that when a compound of Formula (1) is prepared by the third preferred process the position of substitution by the totality of sulfonic acid and sulfonamide groups will be known. However the product will be a polydisperse mixture containing different species with differing levels of sulfonic acid and sulfonamide substituents. Thus when a compound is prepared by this third preferred process the sum of m plus n will be equal to the amount of sulfonic acid, or an active analogue thereof, residues initially present on the intermediate i.e. the sum of m plus n will be an integer. However, the values of n and m will not be integers but rather averages of the total amount of sulfonic acid and sulfonamides residues present in the compound of Formula (1).

In a fourth preferred process an intermediate is assembled which corresponds to a compound of Formula (1) but carries no sulfonic acid or sulfonamide groups. This intermediate is then reacted with chlorosulfonic acid and optionally a chlorinating agent (e.g. POCl₃, PCl₅ or thionyl chloride) to yield an intermediate carrying sulfonyl chloride groups. This intermediate may then be reacted with an amide as in the third general process. In the products of the fourth preferred process n and m will not be integers but rather averages of the total amount of sulfonic acid and sulfonamides residues present in the dye.

One advantage of the second to fourth (especially the fourth) preferred process is that it is possible to prepare dyes of Formula (1) at a lower cost than those prepared by the first preferred process.

The compounds of Formula (1) are valuable colorants for use in the preparation of ink-jet printing inks, especially magenta inks. They benefit from a good balance of solubility, storage stability and fastness to ozone and light. In particular they display excellent ozone fastness.

According to a second aspect of the present invention there is provided a composition comprising a compound of Formula (1) and/or a salt thereof, as described in the first aspect of the invention, and a liquid medium.

Preferred compositions according to the second aspect of the invention comprise:
(a) from 0.01 to 30 parts of a compound of Formula (1) and salts thereof according to the first aspect of the invention; and
(b) from 70 to 99.99 parts of a liquid medium;
   wherein all parts are by weight.

Preferably the number of parts of (a)+(b)=100. The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%.

This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration magenta ink, a low concentration magenta ink or both a high concentration and a low concentration ink. In the latter case this can lead to improvements in the resolution and quality of printed images. Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones, preferably sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

When the liquid medium comprises organic solvent free from water, (i.e. less than 1% water by weight) the solvent preferably has a boiling point of from 30 to 200° C., more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the ink to modify the shade and performance properties.

It is preferred that the composition according to the invention is ink suitable for use in an ink-jet printer. Ink suitable for use in an ink-jet printer is ink which is able to repeatedly fire through an ink-jet printing head without causing blockage of the fine nozzles. To do this the ink must be particle free, stable (i.e. not precipitate on storage), free from corrosive elements (e.g. chloride) and have a viscosity which allows for good droplet formation at the print head.

Ink suitable for use in an ink-jet printer preferably has a viscosity of less than 20 cP, more preferably less than 10 cP, especially less than 5 cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colourant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

A third aspect of the invention provides a process for forming an image on a substrate comprising applying a composition, preferably ink suitable for use in an ink-jet printer, according to the second aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. The substrate is preferably paper, plastic, a textile, metal or glass, more preferably paper, an overhead projector slide or a textile material, especially paper.

Preferred papers are plain or treated papers which may have an acid, alkaline or neutral character. Photographic quality papers are especially preferred. Photographic quality paper give a similar finish to that typically seen with silver halide photo printing.

A fourth aspect of the present invention provides a material preferably paper, plastic, a textile, metal or glass, more preferably paper, an overhead projector slide or a textile material, especially paper more especially plain, coated or treated papers printed with a compound as described in the first aspect of the invention, a composition according to the second aspect of the invention or by means of a process according to the third aspect of the invention.

It is especially preferred that the printed material of the fourth aspect of the invention is a print on a photographic quality paper printed using a process according to the third aspect of the invention.

A fifth aspect of the present invention provides an ink-jet printer cartridge comprising a chamber and a composition, preferably ink suitable for use in an ink-jet printer, wherein the composition is in the chamber and the composition is as defined and preferred in the second aspect of the present invention. The cartridge may contain a high concentration ink and a low concentration ink, as described in the second aspect of the invention, in different chambers.

The invention is further illustrated by the following Examples in which all parts and percentages are by weight unless otherwise stated. In the Examples shown below where the exact position and number of the sulfonamide and/or sulfonic acid substituents is not known then the number of sulfonamide and/or sulfonic acid substituents is shown as an average figure outside a bracketed compound of Formula (1). In some of the Examples shown below it would be obvious to a skilled addressee that the sulfonamide and/or sulfonic acid groups were attached only at particular positions in the compounds of Formula (1).

### EXAMPLE 1

### Preparation of

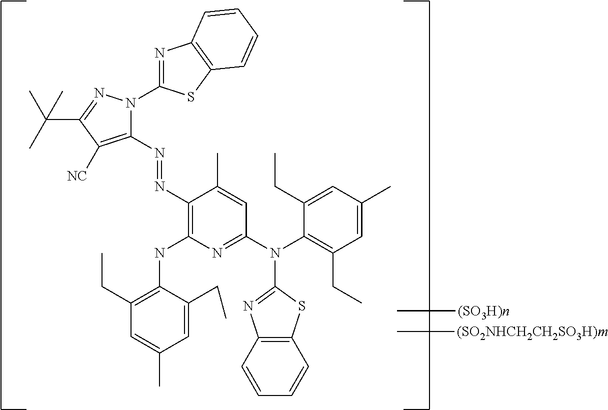

wherein n plus m is 4

### Stage (a)

### Preparation of Intermediate (1a)

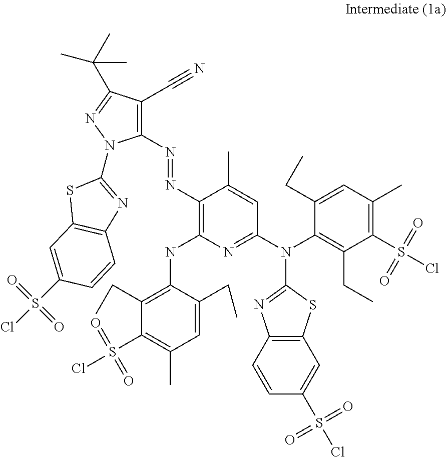

Compound d5 of US20060009357, was prepared as described in US20060009357. Compound d5 of US20060009357 (40 g, 0.034 mol) was added to thionyl chloride (235 g) cooled at 0-10° C. DMF (10 ml) was added to the reaction mixture which was subsequently stirred at a temperature of 0-10° C. for 2 hours. The reaction mixture was stirred for a further 2 hours at 50° C. before cooling to room temperature and adding to hexane (2000 ml). The precipitate which formed was collected by filtration, dissolved in dichloromethane (500 ml), screened through filter aid and evaporated to leave 44 g of a red solid.

### Stage 1(b)

### Preparation of the Title Compound

A solution of taurine (12.5 g, 0.1 mol) and tetramethylammonium hydroxide (9.1 g, 0.1 mol) in methanol (200 ml) was evaporated to dryness. A solution of the residue in methanol (100 ml) was cooled to 0° C. followed by the portion wise addition of compound 1a (12.5 g, 0.01 mol). The reaction mixture was stirred for 16 hours at 20-25° C. and then added to propan-2-ol (300 ml). The precipitate was collected by filtration and washed with propan-2-ol (100 ml). The crude product was dissolved in water (100 ml) and dialysed to low conductivity. The solution was dried in an oven at 60° C. to give 3.6 g of a red solid.

### EXAMPLE 2

### Preparation of

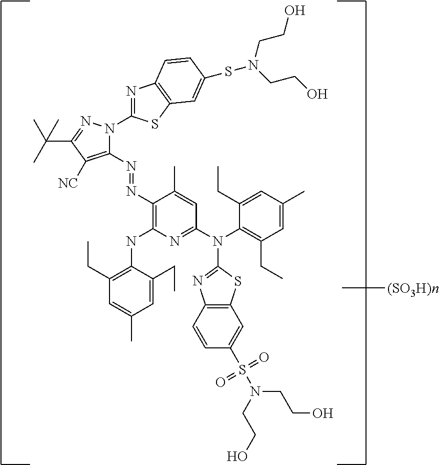

The exact value of n is not known however HPLC shows that the compound of Example 2 is a polydisperse mixture comprising as its major components 40% hexasulfo, 25% pentasulfo and 1% hepatasulfo analogues.

### Stage (a)

### Preparation of Intermediate (2a)

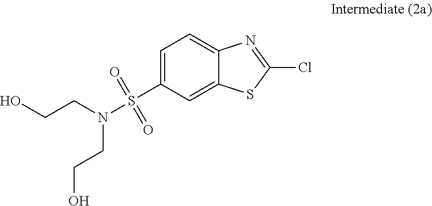

Acetic anhydride (365 g, 3.7 mol) was added drop-wise to a solution of 2-aminobenzothiazole (500 g, 3.33 mol) in acetic acid (1000 ml) at 25-35° C. The reaction mixture was stirred at 60-70° C. for 5 hours, added slowly to ice (4000 g) and stirred for a further 1 hour. The solid which formed was collected by filtration, washed with water (2×500 ml) and dried in an oven at 60° C. The solid (134 g, 0.70 mol) was then added in portions over 30 minutes to chlorosulfonic acid (500 ml) at 20-30° C. The reaction mixture was stirred for 3 hours at 60-70° C., cooled to room temperature and added drop-wise to ice (3000 kg). The resultant precipitate (a sulfonylchloride compound) was collected by filtration, washed with cold water (2×500 ml) and used as a damp paste. The sulfonylchloride compound (formed above) was added in portions to a solution of diethanolamine (184 g, 1.75mo1) in a mixture of water (500 g) and acetone (500 g) at 0-5° c. The reaction mixture was allowed to warm to room temperature and stirred overnight. The precipitate which formed (an acetyl sulfonamido compound) was collected by filtration, washed with water (2×500 ml) and dried in an oven at 60° C. The sulfonamido compound was then stirred in a solution of sodium hydroxide (28 g, 0.70 mol) in water (500 ml) at 70-75° C. for 6 hours. The reaction mixture was allowed to cool, the product collected by filtration, washed with water (2×500 ml) and pulled dry. The resultant compound was dissolved in a mixture of water (500 ml) and concentrated hydrochloric acid (500 ml) and a solution of sodium nitrite (53 g, 0.76mol) in water (50 ml) was added drop-wise to the reaction mixture at 20-30° C. The reaction mixture was then stirred at 30-35° C. for 2 hours and the crude product was collected by filtration and washed with water (2×500 ml). The solid obtained was stirred in water (1000 ml), the pH of the suspension adjusted to 6.5 with a solution of sodium hydrogen carbonate and the solid was once again collected by filtration. The solid was then dried in an oven to give 72 g of a tan powder.

### Stage (b)

### Preparation of Intermediate (2b)

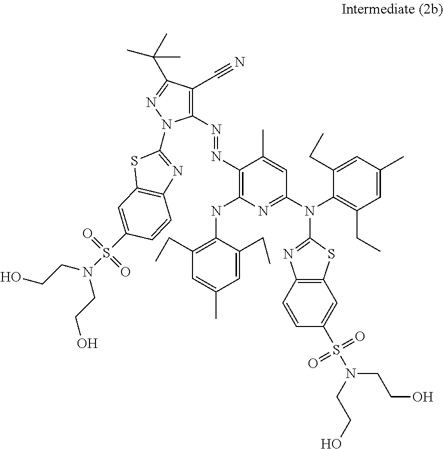

A mixture of intermediate 2a (13.5 g, 0.04 mol), the monoazo compound (6.3 g, 0.01 mol) prepared as described in US2006/0009357 (compound d5a) and potassium carbonate (5.5 g, 0.04 mol) in dimethylsulfoxide (20 ml) was stirred at 45° C. for 4 hours. The reaction mixture was added to methanol (500 ml) and the resultant precipitate collected by filtration. The crude product was purified by column chromatography on silica gel eluting with ethyl acetate.

### Stage 2(c)

### Preparation of the Title Compound

Intermediate (2b) (1 g) was added to 20% oleum (15 ml) at 0-10° C. The reaction mixture was stirred for 4 hours at 20-25° C. and then added slowly to crushed ice (100 g). The pH of the solution thus obtained was adjusted to 7 with sodium hydroxide solution and the solution was then dialysed to low conductivity. The solution was dried in an oven at 60° C. to give 1 g of a red solid.

### EXAMPLES 3 TO 13

In all of these Examples n plus m is 4, a and b are both O and R² is methyl. Examples 3 to 10 were prepared according to Example 1 except that in stage 1(b) taurine was replaced by the amino compound as shown in the Table below. Examples 11 to 13 were prepared according to Example 2 except that in stage 2 (a) diethanolamine was replaced by the amino compound as shown in the Table below.

| Example | R¹ | R³ | Amino compound |
|---|---|---|---|
| 3 | C₂H₅ | tert-Butyl | 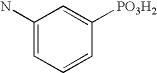 |
| 4 | C₂H₅ | 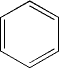 | 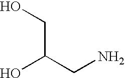 |
| 5 | CH₃ | tert-Butyl | 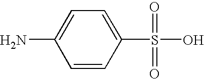 |
| 6 | C₂H₅ | tert-Butyl | 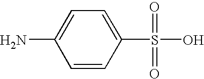 |
| 7 | CH₃ | 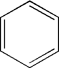 | 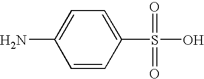 |
| 8 | C₂H₅ | 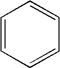 | 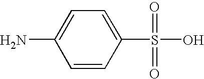 |
| 9 | CH₃ | tert-Butyl | 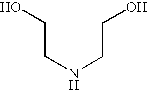 |
| 10 | C₂H₅ | tert-Butyl | 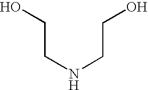 |
| 11 | C₂H₅ | tert-Butyl | 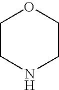 |
| 12 | CH₃ | tert-Butyl | 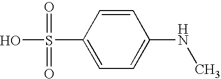 |
| 13 | C₂H₅ | 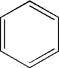 | 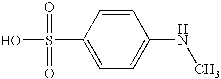 |

### EXAMPLE 14

### Preparation of

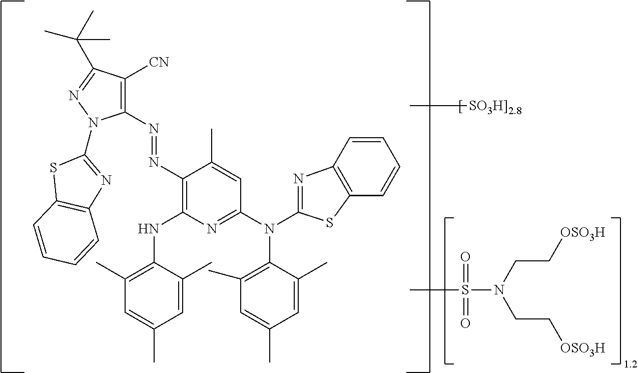

### Stage (a)

### Preparation of Intermediate 14 (a)

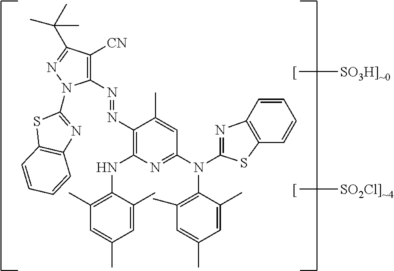

Compound d6 of US20060009357, was prepared as described in US20060009357. Compound d6 of US20060009357 (25.7 g, 0.018mol) was added to thionyl chloride (80 ml) and the mixture was cooled to 15° C. A few drops of dimethylformamide were added. After stirring for 1 hour the temperature of the reaction was raised to 50° C. for a further 1 hour. The reaction mixture was cooled to 25° C., poured into hexane (400 ml) and the mobile liquid phase decanted from the oily product. The oil was taken up in dichloromethane, affording a solid that was removed by filtration. The filtrate, containing the title compound was concentrated and then reconstituted in dichloromethane before concentrating again, to give the acid chloride (31.2 g).

### Stage (b)

### Formation of the Sulfonamide/Sulfonic Acid

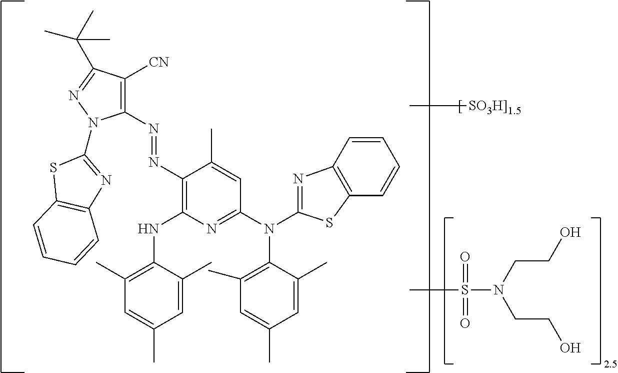

Diethanolamine (4.2 g, 10 equiv) was dissolved in water (260 ml) at pH 2. The acid chloride (4.8 g, 0.004mol) prepared in stage 1 was added to this aqueous solution and the pH raised to pH 8, using 2M lithium hydroxide. The reaction mixture was warmed to 70° C. for 16 hours, maintaining the pH in the range of 8 to 9. The reaction mixture was then filtered and dialysed using Visking tubing. After concentration 2.5 g of the title compound was collected, with an average 2.5 sulfonamides per molecule, determined by analysis by ¹H NMR spectroscopy.

### Stage (c)

### Additional Sulfonation

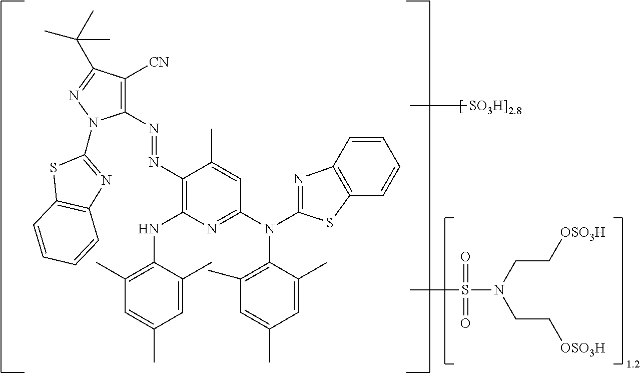

The hydroxy sulfonamide (1.5 g) from stage (b) was added to 20% fuming sulfuric acid (6 ml) containing phosphorus pentoxide (0.15 g) at 5 to 10° C. The reaction mixture was stirred allowing the temperature to slowly rise to 21° C. over 2 hours. The reaction mixture was then added to iced water and the solution was dialysed using Visking tubing. The collected solution was neutralised using 2M lithium hydroxide, filtered, then dialysed again. The product collected (1.35 g) on evaporation of the water, contained 1.2 sulfonamides per molecule, determined by ¹H NMR spectroscopy.

### COMPARATIVE EXAMPLE

Example dye F1 from U.S. Pat. No. 7,108,743 was used as a comparative example:

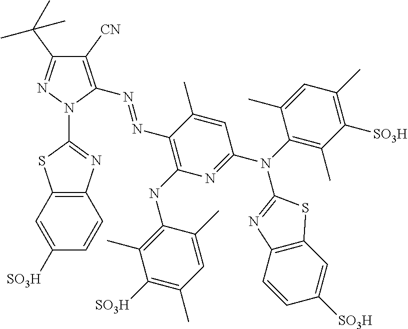

### EXAMPLE 15

### Preparation of Inks

Example Inks and a Comparative Ink were prepared by dissolving 3.2 g of the dye of Example 1, 3 and 6 or the Comparative Example dye in a liquid medium comprising (% by weight):

| | |
|---|---|
| Diethyleneglycol | 7% |
| 2-Pyrollidone | 7% |
| Ethyleneglycol | 7% |
| Surfynol^{RTM} 465 | 1% |
| Tris buffer | 0.2% |
| Water | 77.8% |

Surfynol^{RTM} 465 is a surfactant from Air Products.

### EXAMPLE 16

### Ink-Jet Printing

The inks prepared above were filtered through a 0.45 micron nylon filter and then incorporated into empty print cartridges using a syringe.

These inks were then ink-jet printed on to the following ink-jet media at 50% depth:

Epson Ultra Premium Glossy Photo Paper (SEC PM);

Canon Premium PR101Photo Paper (PR101); and

HP Advanced Photo Paper (HPP).

The resultant prints were tested for ozone fastness by exposure to 5 ppm ozone at 25° C., 50% relative humidity for 24 hours in a Hampden 903 Ozone cabinet. Fastness of the printed ink to ozone was judged by the difference in the optical density before and after exposure to ozone.

Optical density measurements can be performed using a Gretag Macbeth Spectrolino® spectrophotometer set to the following parameters :

| | |
|---|---|
| Measuring Geometry | 0°/45° |
| Spectral Range | 380-730 nm |
| Spectral Interval | 10 nm |
| Illuminant | D50 |
| Observer | 2° (CIE 1931) |
| Density | Ansi A |
| External Filler | None |

Ozone fastness was assessed by the percentage change in the optical density of the print, where a lower figure indicates higher fastness. Even the change of a few percent can correlate to a significant improvement in performance.

| Dye | SUBSTRATE | ROD LOSS % |
|---|---|---|
| Comparative | HPP | 14 |
| Example F1 | PR101 | 31 |
| | SEC PM | 17 |
| Example 1 | HPP | 4 |
| | PR101 | 15 |
| | SEC PM | 5 |
| Example 3 | HPP | 6 |
| | PR101 | 14 |
| | SEC PM | 6 |
| Example 6 | HPP | 5 |
| | PR101 | 16 |
| | SEC PM | 5 |

Clearly prints formed using the dyes of the present invention display a significant improvement in ozone fastness.

### Further Inks

The inks described in Tables A and B may be prepared using the compound of Example 1. The dye indicated in the first column is dissolved in 100 parts of the ink as specified in the second column on. Numbers quoted in the second column onwards refer to the number of parts of the relevant ink ingredient and all parts are by weight. The pH of the ink may be adjusted using a suitable acid or base. The inks may be applied to a substrate by ink-jet printing.

The following abbreviations are used in Tables A and B:

PG=propylene glycol

DEG=diethylene glycol

NMP=N-methylpyrrolidone

DMK=dimethylketone

IPA=isopropanol

2P=2-pyrrolidone

MIBK=methylisobutyl ketone

P12=propane-1,2-diol

BDL=butane-2,3-diol

TBT=tert-butanol

TABLE A

| Dye | Water | PG | DEG | NMP | DMK | IPA | 2P | MIBK |
|---|---|---|---|---|---|---|---|---|
| 2.0 | 80 | 5 | | 6 | 4 | | 5 | |
| 3.0 | 90 | | 5 | 5 | | | | |
| 10.0 | 85 | 3 | | 3 | 3 | | 6 | |
| 2.1 | 91 | | 8 | | | | | 1 |
| 3.1 | 86 | 5 | | | | 4 | | 5 |
| 1.1 | 81 | | | 9 | | | 10 | |
| 2.5 | 60 | 4 | 15 | 3 | 3 | 6 | 5 | 4 |
| 5 | 65 | | 20 | | | 10 | 5 | |
| 2.4 | 75 | 5 | 10 | | 5 | | | 5 |
| 4.1 | 80 | 3 | 5 | 2 | 10 | | | |
| 3.2 | 65 | | 5 | 4 | 6 | 5 | 10 | 5 |
| 5.1 | 96 | | | | | | 4 | |
| 10.8 | 90 | 5 | | | | 5 | | |
| 10.0 | 80 | 2 | 6 | 2 | 5 | 1 | 4 | |
| 1.8 | 80 | | 5 | | | | 15 | |
| 2.6 | 84 | | | 11 | | | 5 | |
| 3.3 | 80 | 4 | | | 10 | | | 6 |
| 12.0 | 90 | | | | 7 | 3 | | |
| 5.4 | 69 | 2 | 20 | 2 | 1 | | 3 | 3 |
| 6.0 | 91 | | | 4 | | | 5 | |

TABLE B

| Dye | | | | | | | |
|---|---|---|---|---|---|---|---|
| Content | Water | PG | DEG | NMP | TBT | BDL | PI2 |
| 3.0 | 80 | 20 | | | | | |
| 9.0 | 90 | | 5 | | | | 5 |
| 1.5 | 85 | 5 | 5 | | 5 | | |
| 2.5 | 90 | | 6 | 4 | | | |
| 3.1 | 82 | 4 | 8 | | | | 6 |
| 0.9 | 85 | | 10 | | | 5 | |
| 8.0 | 90 | | 5 | 5 | | | |
| 4.0 | 70 | | 10 | 4 | | 5 | 11 |
| 2.2 | 75 | 10 | 10 | 3 | | 2 | |
| 10.0 | 91 | | | 9 | | | |
| 9.0 | 76 | | 9 | 7 | 3 | 5 | |
| 5.0 | 78 | 5 | 11 | | | 6 | |
| 5.4 | 86 | | | 7 | 7 | | |
| 2.1 | 70 | 5 | 10 | 5 | 5 | 5 | |
| 2.0 | 90 | | 10 | | | | |
| 2 | 88 | | 12 | | | | |
| 5 | 78 | | | 5 | | 7 | 10 |
| 8 | 70 | 2 | 20 | 8 | | | |
| 10 | 80 | 10 | 10 | | | | |
| 10 | 80 | | 20 | | | | |

1. A compound of Formula (1) and salts thereof: 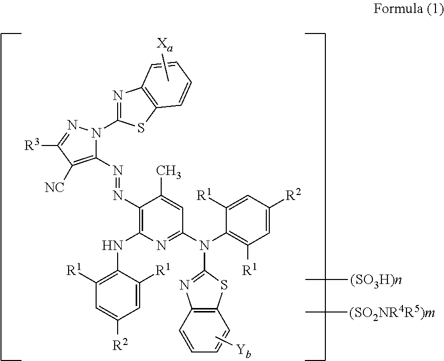
wherein:
R¹ and R² are independently H or optionally substituted C₁₋₄alkyl;
R³ is optionally substituted alkyl, optionally substituted aryl or optionally substituted heteroaryl;
R⁴ and R⁵ are independently H, optionally substituted alkyl, optionally substituted aryl or optionally substituted heteroaryl with the proviso that R⁴ and R⁵ do not carry a carboxylic acid substituent;
X and Y are independently an acetyl group, an acetate ester group, an amide group, a sulfoxide group, a sulfone group, a phosphonate group, a nitro group, a nitrile group, an isonitrile group, a quaternary amine, a carbonyl group (other than a carboxylic acid), a polyhaloalkyl group or a halogen atom;
(a+b)=0 to 4;
n is in the range of from 1 to 7; and
m is greater than 0.

2. A compound of Formula (1) and salts thereof as claimed in claim 1 wherein R¹ and R² are independently H or unsubstituted C₁₋₄alkyl.

3. A compound of Formula (1) and salts thereof as claimed in claim 1 wherein R¹ is methyl or ethyl.

4. A compound of Formula (1) and salts thereof as claimed in claim 1 wherein R³ is optionally substituted C₁₋₈ alkyl, optionally substituted phenyl or optionally substituted naphthyl.

5. A compound of Formula (1) and salts thereof as claimed in claim 1 wherein R⁴ and R⁵ are independently H, alkyl carrying at least one sulfonic or phosphonic acid substituent, C₁₋₄-alkyl carrying one or two hydroxy substituent(s) or aryl carrying at least one sulfonic or phosphonic acid substituent.

6. A compound of Formula (1) and salts thereof as claimed in claim 1 wherein R⁴ and R⁵ are both hydroxyethyl.

7. A compound of Formula (1) and salts thereof as claimed in claim 1 wherein X and Y are independently —Cl or —SO₂R⁶ wherein R⁶ is optionally substituted alkyl, optionally substituted aryl or optionally substituted heterocyclyl.

8. A compound of Formula (1) and salts thereof as claimed in claim 1 wherein (a+b) is 0.

9. A compound of Formula (1) and salts thereof as claimed in claim 1 wherein n is in the range of from 4 to 7.

10. A compound of Formula (1) as claimed in claim 1 which is of Formula (2) and salts thereof: 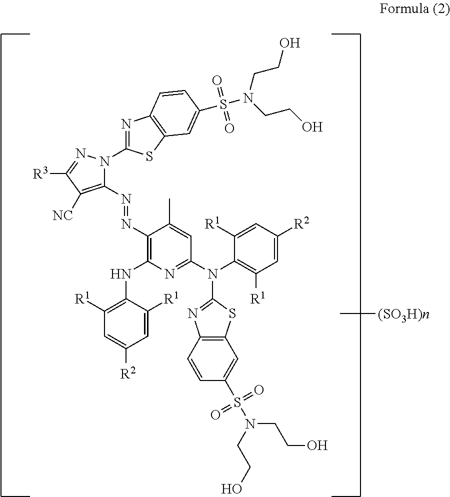
wherein:
R¹ and R² are independently H or optionally substituted C₁₋₄alkyl;
R³ is optionally substituted alkyl, optionally substituted aryl or optionally substituted heteroaryl; and
n is in the range of from 1 to 7.

11. A composition comprising a compound of Formula (1) and/or a salt thereof, as described in, and a liquid medium.

12. A composition as claimed in claim 10 which is ink suitable for use in an ink-jet printer.

13. A process for forming an image on a substrate comprising applying ink suitable for use in an ink jet printer, according to claim 12, thereto by means of an ink-jet printer.

14. A material printed with a compound as described in claim 1.

15. An ink-jet printer cartridge comprising a chamber and ink suitable for use in an ink-jet printer, according to claim 12, wherein the ink is in the chamber.
